(19) United States
(12) Patent Application Publication
(10) Pub. No.: US 2025/0289494 A1
(43) Pub. Date: Sep. 18, 2025

(54) Mechanical steering wheel turn-end-stop device for use in steer-by-wire steering systems, steering column and method

(71) Applicant: ETO MAGNETIC GmbH, Stockach (DE)

(72) Inventors: David Savage, Alto, MI (US); David Adlof, Allendale, MI (US)

(21) Appl. No.: 18/603,728

(22) Filed: Mar. 13, 2024

(51) Int. Cl. B62D 5/00

(52) U.S. Cl. CPC B62D 5/005

(57) ABSTRACT

A mechanical steering wheel turn-end-stop device for use in steer-by-wire steering systems, comprising a connection element, which is configured for establishing a physical connection with a steering wheel shaft of a steering wheel, and which is configured for performing a coupled movement together with a physically connected steering wheel when the steering wheel is turned, and comprising a mechanical stop element, forming a limit stop for the connection element, preventing a further movement of the connection element in at least one movement direction and, via the established physical connection with the steering wheel shaft, preventing a further turning of the connected steering wheel in at least one turning direction is proposed.

### STATE OF THE ART

The invention relates to a mechanical steering wheel turn-end-stop device, a steering column and a method for providing tactile lock-to-lock steering feedback to a user of a steer-by-wire steering system.

Steer-by-wire steering systems for vehicles have been proposed. When a physical connection to a steering rack is removed as it is the case in those steer-by-wire steering systems, the tactile/physical feedback of full left and full right stops is lost to the user, for example a driver of a vehicle.

The objective of the invention is in particular to provide a device with advantageous properties regarding a user feedback in steer-by-wire systems. In particular, the invention aims to overcome the above-mentioned issue of steer-by-wire systems. The objective is achieved, according to the invention, by the features of the independent claims while advantageous implementations and further developments of the invention may be gathered from the subordinate claims.

### Advantages of the Invention

A mechanical steering wheel turn-end-stop device for use in steer-by-wire steering systems, comprising a connection element, which is configured for establishing a physical connection with a steering wheel shaft of a steering wheel, and which is configured for performing a coupled movement together with a physically connected steering wheel when the steering wheel is turned, and comprising a mechanical stop element, forming a limit stop for the connection element, preventing a further movement of the connection element in at least one movement direction and, via the established physical connection with the steering wheel shaft, preventing a further turning of the connected steering wheel shaft, and in particular the connected steering wheel, in at least one turning direction is proposed. By this design a tactile end-stop feedback can advantageously be added to steer-by-wire steering systems. Thus, an improved user experience can advantageously be achieved. Additionally, an operational safety of steer-by-wire steering systems can advantageously be increased, for example by preventing an overturning of a steering wheel. Furthermore, a user-acceptance of steer-by-wire steering systems can be improved, as the feel when using steer-by-wire steering systems is advantageously aligned with the feel of conventional steering systems with physical steering linkage. In turn, the production costs of vehicles can advantageously be lowered when steer-by-wire steering systems are installed.

The mechanical steering wheel turn-end-stop device is in particular using physical stops to prevent a further turning of a steering wheel. Preferably, the mechanical steering wheel turn-end-stop device is different from purely electronic steering wheel turn-end-stop devices. The steering wheel turn-end-stop device is in particular configured for setting a maximum left turn angle and/or a maximum right turn angle of a steering wheel of a vehicle. A steer-by-wire system, in particular in the context of the automotive industry, is preferably to be understood as a system that allows steering some or all of a vehicle's wheels without a steering column connected to the wheel axles. It is in particular different from electric power steering or power-assist, as those steering systems still rely on the steering column to transfer some steering torque to the wheels. The connection element can be implemented as a gear element. The connection element can be implemented as a sintered metallic, ceramic and/or plastic (e.g. Polyoxymethylene) element. The connection element can be implemented as a monolithic part or as a one-piece part which is composed of two or more components that are molded with each other. The connection element preferably is connected to the steering wheel shaft in a way that it follows rotational movements of the steering wheel shaft. The connection element in particular is connected to the steering wheel shaft in a way that it is movable along an axial extension of the steering wheel shaft. Preferably, the axial movement of the connection element along the steering wheel shaft is restricted by guide elements, which in particular can be an integral part of the steering wheel shaft. Preferably, the connection element encompasses a section of the steering wheel shaft completely. However, partially encompassing connection elements are also conceivable. The connection element can be implemented as a steering wheel shaft sleeve which is rotationally fixedly coupled to the steering wheel shaft but allows an axial displacement along the steering wheel shaft. The steering wheel shaft enables a physical connection with a steering wheel. Preferably, the steering wheel shaft on one end provides a connection interface for a connection of the steering wheel. Turning movements of a mounted steering wheel are directly translated into turning movements of the steering wheel shaft. In turn, the turning movements of the steering wheel shaft preferably are directly translated into a spiraling movement of surface points of the connection element. If a movement of the connection element is impeded in any way, for example by abutting on a mechanical stop element, the coupled movement between the connection element and the steering wheel shaft results in an impossibility to further turn the steering wheel shaft and thus the steering wheel in at least one of the two directions of rotation. The mechanical stop elements preferably are robust bodies that provide contact surfaces for the connection element. The mechanical stop elements can be full body metal, ceramic and/or plastic elements. Preferably, the mechanical stop element at the same time prevents an axial movement of the abutting connection element in one of two axial directions and a rotational movement of the abutting connection element in one of two rotational directions.

Furthermore, it is proposed that the mechanical steering wheel turn-end-stop device comprises a further mechanical stop element forming a further limit stop for the connection element, preventing a further movement of the connection element in at least one further movement direction, which is directed opposite to the movement direction, and, via the established physical connection with the steering wheel shaft, preventing a further turning of the connected steering wheel in at least one further turning direction, which is directed opposite to the turning direction. By this design, a tactile end-stop feedback can advantageously be added to both turning directions of steering wheels of steer-by-wire steering systems. Advantageously, the single connection element can be used to provide turn-end-stops in both rotation directions. Preferably, the connection element comprises at least two different abutment surfaces, which are in particular arranged opposite to each other and each of which is configured to interact with a different one of the mechanical stop elements. In particular the term, “configured” shall be understood to mean specially programmed, designed and/or equipped. By “configured” it is to be understood in particular that an object is intended for a certain function, that the object fulfills and/or executes this certain function in at least one application and/or operating state. The further mechanical stop element preferably is made from the same material like the mechanical stop element. The further mechanical stop element can be implemented at least substantially identical to the mechanical stop element. In particular, the mechanical stop elements are robust solid bodies with destined abutment surfaces for an interaction with corresponding abutment surfaces of the connection element.

When the mechanical stop element and the further mechanical stop element are arranged on opposing ends of a longitudinal travel path of the connection element, a particularly simple construction can advantageously be achieved. Advantageously, the same connection element can be used to interact with both mechanical stop elements and thus provide tactile feedback in both turning directions. Preferably, the mechanical stop clement embodies an end cap of a (cylindrical) movement guiding sleeve/tube, the connection element is arranged in. Preferably, the further mechanical stop element embodies a further end cap of the (cylindrical) movement guiding sleeve/tube, the connection element is arranged in. The longitudinal travel path preferably extends along a straight line, in particular connecting the mechanical stop elements, preferably connecting centers of the mechanical stop elements. Sides of the mechanical stop elements which are intended to come into contact with the connection element are arranged facing each other.

In addition, it is proposed that the mechanical stop element and the further mechanical stop element are arranged in a way relative to the connection element, allowing turns of the connection element and thus of a connected steering wheel shaft in the turning direction of at least 360°, preferably of at least 540°, more preferably of at least 720°, preferentially of at least 900° and most preferentially of at most 1200°. By this design, a positive user experience, which in particular provides the user the feel he/she is used from conventional steering systems, can advantageously be achieved. Advantageously, the angle range of allowed steering wheel turns can be easily set, for example by simply selecting the distance of the mechanical stop elements from each other and/or by adjusting a pitch angle of a threaded connection between the connection element and a guide element which translates the rotational movement of a steering wheel into a translational movement of the connection element. In order to make the connection element travel from one mechanical stop element to the other, a turn of the steering wheel of significantly more than 360° is required.

Moreover, it is proposed that the mechanical stop element at the same time implements a longitudinal stop dog preventing a further longitudinal movement of the connection clement towards the at least one movement direction and a rotational stop dog preventing a further rotational movement of the connection element in the at least one turning direction. By this design, a high durability can advantageously be achieved. Advantageously, a wear, in particular a tribological wear, of the components coming into contact with each other can be reduced. A rubbing of the involved elements against each other can advantageously be prevented to a large extent. The longitudinal stop dog and the rotational stop dog of a mechanical stop element are implemented by different surfaces of the mechanical stop element. The surfaces implementing the longitudinal stop dog and the rotational stop dog of the mechanical stop element are arranged directly next to each other, preferably only separated by an edge or ridge of the mechanical stop element.

When the mechanical stop element comprises one or more interlock elements, which are configured to interlock with corresponding interlock elements of the connection element in order to prevent a further rotational movement of the connection element in the at least one turning direction when physical contact between the connection element and the mechanical stop element is established, a particularly advantageous construction can be achieved. Preferably, the corresponding interlock elements comprise surfaces that are directed opposite to each other. Preferably, the surfaces of the interlock elements at least have a radial component relative to an axial direction of the steering wheel shaft or of a receiving region of the connection element to receive the steering wheel shaft. Preferably, this radial component of the surfaces of the interlock elements is larger than the respective axial components of those surfaces.

When the interlock elements and/or the corresponding interlock elements are implemented as (with respect to the axial direction) circumferentially interlocking teeth, a particularly advantageous easy and durable construction can be achieved. Since the interlocking teeth are separate and different to the parts that guide the motion of the connection element along the steering shaft (see the description of corresponding ribs and grooves below) and separate and different to the guide elements that guide a spiral movement of the connection element upon a turning of the steering shaft (see the description of Acme threads below), high rotation loads can be achieved without a risk of jamming the steering column or causing the steering function of the steering function to be degraded.

It is further proposed that the connection element comprises further corresponding interlock elements on a side of the connection element, which is opposite to the side of the connection element the corresponding interlock elements are located at. Thus, an advantageously simple and inexpensive construction can be achieved. The further corresponding interlock elements are preferably configured to interlock with corresponding further interlock elements of the further mechanical stop element. While the corresponding interlock elements are configured to limit a turning of the steering wheel in a first direction of rotation (e.g. the clockwise direction), the further corresponding interlock elements are configured to limit a turning of the steering wheel in a second direction that is different from the first direction (e.g. the counter-clockwise direction).

Furthermore, it is proposed that the connection element is configured for establishing a rotationally fixed and longitudinally movable physical connection with a steering wheel shaft. Thereby, the connection element is advantageously able to pick up a rotational movement of the steering wheel and translate it into a longitudinal movement of the connection element between the two mechanical stop elements. Advantageously, a particularly easy and inexpensive construction can be achieved. A rotationally fixed movement between two components should in particular be understood in a way that a rotation of one of the components always results in a similar rotation of the other component. A longitudinally movable physical connection between two components should in particular be understood in a way that a longitudinal movement of at least one of the components does not have any effect on a longitudinal movement of the other component. A longitudinal movement of one of the components, in particular of the connection element, with respect to the other component, in particular the steering wheel shaft, is explicitly allowed by the longitudinally movable physical connection. In particular, the connection element is configured to rotate with the steering wheel shaft but meanwhile may travel up and down the longitudinal extension of the steering wheel shaft.

When the connection element comprises a receiving recess for an all-round (360°) reception of the steering wheel shaft, an advantageous coupling of the connection element and the steering wheel shaft can be achieved. Advantageously, an even force distribution within the connection element can be achieved. Advantageously, a long lifetime of the mechanical steering wheel turn-end-stop device can be achieved. The receiving recess in particular is implemented as a circular hole within the connection clement, which has a profiled inner surface for establishing the rotationally fixed connection to an oppositely profiled outer surface of the steering wheel shaft. The connection element roughly (apart from surface profiling, surface threads, etc.) has ring-like or hollow-cylinder-like shape. A circumference of the receiving recess is encompassed completely by material of the connection element. The receiving recess passes the connection element completely. The receiving recess is implemented as an axial through-hole that is completely passing the connection element. The receiving recess may have a constant cross sectional area and/or cross sectional contour.

In addition, it is proposed that the receiving recess comprises straight grooves and/or ribs, which are configured to engage with straight ribs and/or grooves of the steering wheel shaft in case of a physical connection between the connection element and the steering wheel shaft. Thus, an easy, stable and/or inexpensive connection method for connecting the steering wheel shaft can be provided. Advantageously an easy installation can be achieved. Advantageously, an efficient pick up of rotational movements of the steering wheel shaft by the connection element can be achieved while a more or less free movement of the connection element along the axial direction of the steering wheel shaft remains possible. The ribs and/or grooves of the connection element are adapted to fit together with the ribs and/or grooves of the steering wheel shaft, in particular in a way which still allows the longitudinal movement of the connection element relative to the steering wheel shaft (e.g. a clearance fit). A contour of a cross section of the receiving recess has a shape that resembles a star-contour or a jagged circle-contour. A contour of a cross section of the steering wheel shaft has a shape that resembles a star-contour or a jagged circle-contour. A “physical connection” between two objects is in particular to be understood as a connection in which at least surfaces of the two objects touch each other.

Moreover, it is proposed that the connection element comprises a movement guide element on a radial outer surface. Thereby, an advantageous movement control of the connection element can be achieved. Advantageously, a controlled translation of the rotational movement of the steering wheel into the translational movement of the connection element can be achieved. The movement guide element is in particular arranged on a side of the connection element which is facing away from the receiving receptacle. Preferably, the guide element acts as a cam gear. Preferably, the guide element translates the rotational movement of the steering wheel, which is transferred from the steering wheel shaft to the connection element by the respective engaging grooves and ribs into a translational/longitudinal movement of the connection element towards one of the stop elements, depending on the direction of rotation of the steering wheel. Opposite rotation directions of the steering wheel will preferably result in opposite translational/longitudinal movements of the connection element, which are in particular directed towards different mechanical stop elements of the mechanical steering wheel turn-end-stop device.

It is further proposed that the guide element is implemented as an outer thread. Thereby an advantageously reliable and easy translation of movement types can be achieved. The outer thread preferably is arranged on an outer radial surface of the connection element. The outer thread preferably is configured for an interaction with an inner thread of a further element surrounding the connection element. The outer thread extends in particular over at least 360° around an outer circumference of the connection element. Preferably, the outer thread extends over more than 360°, preferentially over more than 540°, around the outer circumference of the connection element. Preferably, the outer thread is implemented as a trapezoidal thread form.

When the guide element is implemented as an Acme thread, a particularly high operational safety can advantageously be achieved. A jamming risk of the connection element can advantageously be kept very low. Furthermore, a particularly low wear and/or a high threading strength can advantageously be achieved. Furthermore, an easy machining of the connection element can advantageously be achieved. The Acme thread form in particular has a 29° thread angle with a thread height half of a thread pitch. Additionally, an apex (or crest) and a valley (or root) of the Acme thread can be flat.

It is further proposed that the mechanical steering wheel turn-end-stop comprises a sleeve element forming an at least substantially cylindrical inner receiving region at least for receiving the connection element and the steering wheel shaft. Thereby, an advantageous construction of the mechanical steering wheel turn-end-stop device can be achieved. The connection element is fit tightly into the receiving region of the sleeve element. Outer surface elements of the connection element interact and/or inter-engage with inner surface elements within the receiving region of the sleeve element. The steering wheel shaft preferably is rotatable within the sleeve element. The connection element preferably is rotatable within the sleeve element. The steering wheel shaft preferably is axially fixed within the sleeve element. The connection element preferably is axially movable within the sleeve element. The sleeve element preferably does not rotate or move in any other way. Preferably, the sleeve element is fixedly arranged within the mechanical steering wheel turn-end-stop device and/or within a steering column of a steer-by-wire steering system comprising the mechanical steering wheel turn-end-stop device. The sleeve element may be arranged within a crash tube of the steering column. The sleeve element may roughly have a hollow-cylinder-like shape. The sleeve element may be made from a metallic, ceramic and/or plastic (e.g. molded from Polyoxymethylene) material.

It is additionally proposed that the mechanical stop element is arranged at a longitudinal end of the sleeve element. In connection with that it is additionally proposed that the further mechanical stop element of the mechanical steering wheel turn-end-stop device is arranged at a further longitudinal end of the sleeve element. Thereby an advantageous, in particular compact, construction of the mechanical steering wheel turn-end-stop device can be achieved. Preferably, the mechanical stop element and/or the further mechanical stop element implement end cap(s) of the sleeve element, in particular partially closing the sleeve element, preferably the receiving region of the sleeve element, in the axial direction. Thereby, the end caps close the receiving region of the sleeve element to an extent that the connection element is captive in the receiving region. The end caps however leave an opening for the steering wheel shaft. The steering wheel shaft preferably protrudes from both ends of the sleeve element. Preferably, the mechanical stop elements define the extension of the longitudinal movement path of the connection element (within the sleeve element).

It is moreover proposed that the sleeve element on an inner wall facing the connection element comprises a corresponding (movement) guide element, which is configured to engage with a movement guide element on a radial outer surface of the connection clement. Thereby an advantageous movement control of the connection element can be achieved. Advantageously, a controlled translation of the rotational movement of the steering wheel into the translational movement of the connection element can be achieved. The corresponding guide element is in particular arranged on a side of the sleeve element which is facing towards the connection element. Preferably, the guide element and the corresponding guide element act together as a cam gear. Preferably, the guide element together with the corresponding guide element translates the rotational movement of the steering wheel, which is transferred from the steering wheel shaft to the connection element by the respective engaging grooves and ribs into a translational/longitudinal movement of the connection element towards one of the stop elements, depending on the direction of rotation of the steering wheel.

It is further proposed that the corresponding guide element is implemented as an inner thread. Thereby an advantageously reliable and easy translation of movement types can be achieved. The inner thread preferably is arranged on an inner radial surface of the sleeve element. The inner thread preferably is configured for an interaction with the thread of the connection element. The inner thread extends over more than 360°, preferentially over more than 720°, more preferentially over more than 1180° around the inner circumference of the sleeve element. Preferably, the inner thread comprises several full turns. Preferably, the inner thread of the sleeve element has a longer extension (e.g. at least two times longer) than the outer thread of the connection element. Preferably, the inner thread is implemented as a trapezoidal thread form.

When the corresponding guide element is implemented as an Acme thread, a particularly high operational safety can advantageously be achieved. A jamming risk of the connection element can advantageously be kept very low. Furthermore, a particularly low wear and/or a high threading strength can advantageously be achieved. Furthermore, an easy machining of the connection element can advantageously be achieved. The Acme thread of the fixedly arranged sleeve element forces the guide element to move longitudinally when it is rotated by the steering wheel shaft.

In addition, it is proposed that a striking of the limit stop is configured for generating tactile lock-to-lock steering feedback to a user turning the steering wheel. Thereby an advantageously familiar user experience with steer-by-wire steering systems can be achieved.

Furthermore, a steering column of a steer-by-wire steering system, in particular a steer-by-wire steering column, with the mechanical steering wheel turn-end-stop device and with the steering wheel shaft is proposed. By this design a tactile end-stop feedback can advantageously be added to steer-by-wire steering systems. Thus, an improved user experience can advantageously be achieved. Additionally, an operational safety of steer-by-wire steering systems can advantageously be increased, for example by preventing an overturning of a steering wheel. Furthermore, a user-acceptance of steer-by-wire steering systems can be improved, as the feel when using steer-by-wire steering systems is advantageously aligned with the feel of conventional steering systems with physical steering linkage. In turn, the production costs of vehicles can advantageously be lowered when steer-by-wire steering systems are installed.

It is further proposed that the steering column, in particular the steer-by-wire steering column, comprises a crash tube, wherein the mechanical steering wheel turn-end-stop device is mounted inside the crash tube. Thereby a compact system can advantageously be achieved. Advantageously, the steering column with the mechanical steering wheel turn-end-stop device provides a high flexibility because dimensions of existing steering columns can be retained and the steering column advantageously is mountable into existing vehicle systems/steer-by-wire systems without requiring considerable modifications. Furthermore, advantageously no additional electronics or electronics interfaces are required to include the mechanical steering wheel turn-end-stop device into the steering column. Preferably, the mechanical steering wheel turn-end-stop device is completely mechanical/free of additional electronics. The crash tube in particular is implemented as an energy absorption element of the steering column, which has the task of absorbing an energy that is exerted on the steering wheel during a crash, e.g. by an impact of the driver in the steering wheel. The crash tube could for example be implemented as a tube in which at least the steering wheel shaft is introduced and which is filled with energy absorbing material, like a foam, a compression spring or the like.

Moreover, it is proposed that the steering column comprises an upper bearing supporting the steering wheel shaft in a first end region of the steering wheel shaft and comprising a lower bearing supporting the steering wheel shaft in a second end region of the steering wheel shaft opposite to the first end region, and wherein the connection element of the mechanical steering wheel turn-end-stop device is mounted to the steering wheel shaft between the upper bearing and the lower bearing. Thereby, an advantageous construction can be achieved. In particular, such an including of the mechanical steering wheel turn-end-stop device into the steering column advantageously does not deteriorate its functionality or the user experience. In contrast, the user experience is even improved by including the lock-to-lock steering feedback. The bearings can, for example, be implemented as ball bearings or other similarly functioning bearings, like tapered bearings, etc.

Furthermore, a method for providing tactile lock-to-lock steering feedback to a user of a steer-by-wire steering system is proposed, wherein a physical connection with a steering wheel shaft of the steering wheel system is established using a steering wheel connection element of a mechanical steering wheel turn-end-stop device, wherein by this connection a coupled movement of the connection element together with the physically connected steering wheel is established when the steering wheel shaft is turned, and wherein a further movement of the connection element in at least one movement direction and, via the established physical connection with the steering wheel shaft, a further turning of the connected steering wheel in at least one turning direction is prevented using a mechanical stop element forming a limit stop for the connection element. By this design a tactile end-stop feedback can advantageously be added to steer-by-wire steering systems. Thus, an improved user experience can advantageously be achieved. Additionally, an operational safety of steer-by-wire steering systems can advantageously be increased, for example by preventing an overturning of a steering wheel. Furthermore, a user-acceptance of steer-by-wire steering systems can be improved, as the feel when using steer-by-wire steering systems is advantageously aligned with the feel of conventional steering systems with physical steering linkage.

The mechanical steering wheel turn-end-stop device according to the invention, the steering column according to the invention and the method according to the invention are herein not to be restricted to the applications and implementation forms described above or pictured below. In particular, to fulfill a functionality herein described, the mechanical steering wheel turn-end-stop device according to the invention, the steering column according to the invention and the method according to the invention may comprise a number of respective elements and/or structural components and/or units and/or method steps that differ/s from a number herein mentioned.

### BRIEF DESCRIPTION OF THE DRAWINGS

Further advantages will become apparent from the following description of the drawings. In the drawings, two exemplary embodiments of the invention are depicted. The drawings, the description and the claims contain a plurality of features in combination. Someone skilled in the art will purposefully also consider the features separately and will find further expedient combinations.

It is shown in:

FIG. 1: a schematic cross-sectional drawing of a steering column of a steer-by-wire steering system with a mechanical steering wheel turn-end-stop device,

FIG. 2: a schematic perspective drawing of the mechanical steering wheel turn-end-stop device,

FIG. 3: a schematic perspective cross-sectional drawing of the mechanical steering wheel turn-end-stop device and

FIG. 4: a schematic flowchart of a method for providing the tactile lock-to-lock steering feedback to a user of the steer-by-wire steering system via the mechanical steering wheel turn-end-stop device.

### DESCRIPTION OF THE EXEMPLARY EMBODIMENT

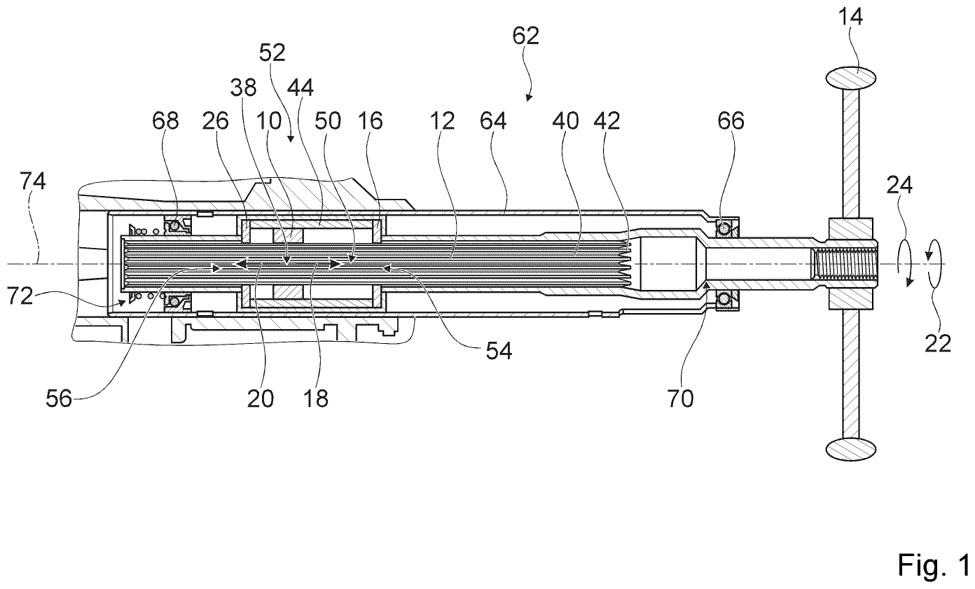

The FIG. 1 shows a schematic cross-sectional drawing of a steering column 62 of a steer-by-wire steering system. The steer-by-wire steering system comprises a steering wheel 14. The steering column 62 comprises a steering wheel shaft 12. The steering wheel 14 is attached to the steering wheel shaft 12. The steering column 62 comprises a crash tube 64. The steering wheel shaft 12 is partially mounted inside the crash tube 64. The steering column comprises 62 an upper bearing 66. The upper bearing 66 supports the steering wheel shaft 12 in a first end region 70 of the steering wheel shaft 12. The steering column 62 comprises a lower bearing 68. The lower bearing 68 supports the steering wheel shaft 12 in a second end region 72 of the steering wheel shaft 12 opposite to the first end region 70. The steering column 62 comprises a mechanical steering wheel turn-end-stop device 52. The mechanical steering wheel turn-end-stop device 52 is mounted entirely inside the crash tube 64. The mechanical steering wheel turn-end-stop device 52 is mounted to the steering wheel shaft 12 between the upper bearing 66 and the lower bearing 68. The mechanical steering wheel turn-end-stop device 52 is configured for generating a tactile lock-to-lock steering feedback to a user turning the steering wheel 14.

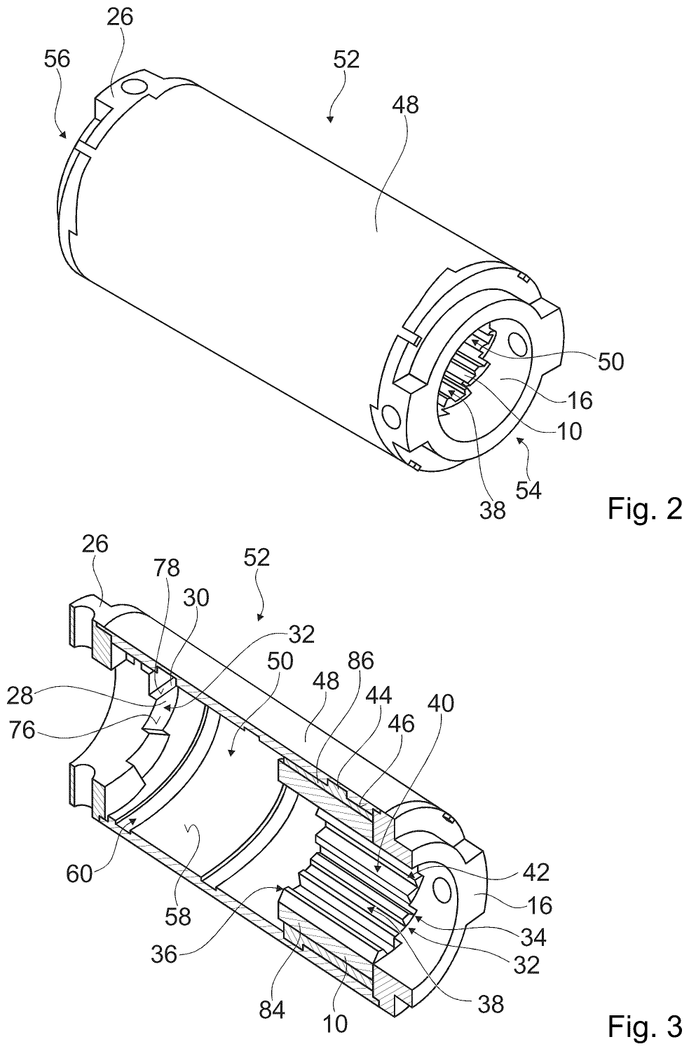

The FIG. 2 shows a schematic perspective drawing of the mechanical steering wheel turn-end-stop device 52. The FIG. 3 shows a cross sectional view from the same perspective, wherein the mechanical steering wheel turn-end-stop device 52 is approximately cut in half along an axial direction 74 of the mechanical steering wheel turn-end-stop device 52. The mechanical steering wheel turn-end-stop device 52 comprises a connection element 10. The connection element 10 is configured for establishing a physical connection with the steering wheel shaft 12. The connection element 10 of the mechanical steering wheel turn-end-stop device 52 is mounted to the steering wheel shaft 12. The connection element 10 is configured for performing a coupled movement together with the physically connected steering wheel 14 when the steering wheel 14 is turned. The connection element 10 is rotatable together with the steering wheel shaft 12 in case the steering wheel shaft 12 is turned in a turning direction 22, 24. The connection element 10 is translatable relative to the steering wheel shaft 12 in movement directions 18, 20 running parallel to the axial direction 74. In summary, surface points of the connection element 10 perform a helical/spiral movement when the steering wheel shaft 12 is turned. The connection element 10 can be embodied monolithically. In the example of FIG. 3, the connection element 10 is formed as a 2-component component with a radially inner part 84 being implemented as a sintered gear element and with a radially outer part 86 being implemented as a threaded element made from molded plastic (e.g. Polyoxymethylene).

The connection element 10 is configured for establishing a rotationally fixed and longitudinally movable physical connection with the steering wheel shaft 12. The connection element 10 comprises a receiving recess 38 for an all-round reception of the steering wheel shaft 12. The receiving recess 38 comprises straight grooves 40 and ribs 42 on an inner surface of the connection clement 10. The straight grooves 40 and ribs 42 are oriented parallel to the axial direction 74. The steering wheel shaft 12 comprises straight ribs 42 and grooves 40 which also are oriented parallel to the axial direction 74. The straight grooves 40 and ribs 42 of the connection element 10 are configured to engage with straight ribs 42 and grooves 40 of the steering wheel shaft 12 in order to establish the physical connection between the connection element 10 and the steering wheel shaft 12.

The mechanical steering wheel turn-end-stop device 52 comprises a mechanical stop element 16. The mechanical stop element 16 forms a limit stop for the connection clement 10. The limit stop formed by the mechanical stop element 16 prevents a further movement of the connection element 10 in the movement direction 18. In addition, via the established physical connection with the steering wheel shaft 12, the limit stop formed by the mechanical stop element 16 prevents a further turning of the steering wheel shaft 12 and/or the connected steering wheel 14 in the turning direction 22. The mechanical steering wheel turn-end-stop device 52 comprises a further mechanical stop clement 26. The further mechanical stop element 26 forms a limit stop for the connection element 10. The limit stop formed by the further mechanical stop element 26 prevents a further movement of the connection element 10 in the movement direction 20 that is opposite to the movement direction 18 hindered by the mechanical stop element 16. In addition, via the established physical connection with the steering wheel shaft 12, the limit stop formed by the further mechanical stop element 26 prevents a further turning of the steering wheel shaft 12 and/or the connected steering wheel 14 in the turning direction 24 that is opposite to the turning direction 22 hindered by the mechanical stop element 16. The striking of the limit stops is generating the tactile lock-to-lock steering feedback.

The mechanical stop element 16 and the further mechanical stop element 26 are arranged on opposing ends of a longitudinal travel path of the connection element 10. The longitudinal travel path of the connection element 10 runs parallel to the axial direction 74. The mechanical stop element 16 and the further mechanical stop element 26 are arranged in a way relative to the connection element 10 that allows turns of the connection element 10 and thus of a connected steering wheel shaft 12 in the turning direction of much more than 360° (>720°).

The mechanical stop element 16 and/or the further mechanical stop element 26 at the same time implements a longitudinal stop dog 28 preventing a further longitudinal movement of the connection element 10 towards the respective translational movement direction 18, 20 and a rotational stop dog 30 preventing a further rotational movement of the connection element 10 in the respective turning direction 22, 24. A striking surface 76 of the longitudinal stop dog 28 at least predominantly faces a side face of the connection element 10. An (imaginary) normal vector to the striking surface 76 of the longitudinal stop dog 28 that is decomposed in the axial direction 74 and in a radial direction perpendicular to the axial direction 74 has a dominant vector component that is parallel to the axial direction 74. A striking surface 78 of the rotational stop dog 30 at least predominantly faces an inner wall 58 of a sleeve element 48 of the mechanical steering wheel turn-end-stop device 52. An (imaginary) normal vector to the striking surface 78 of the rotational stop dog 30 that is decomposed in the axial direction 74 and in the radial direction perpendicular to the axial direction 74 has a dominant vector component that is perpendicular to the axial direction 74.

The mechanical stop element 16 and/or the further mechanical stop element 26 comprises one or more interlock elements 32. The connection element 10 comprises corresponding interlock elements 34 on one of it axial sides. The connection element 10 comprises further corresponding interlock elements 36 on another one of its axial sides. The interlock elements 32 are configured to interlock with the respective corresponding interlock elements 34, 36 of the connection element 10 in order to prevent a further rotational movement of the connection element 10 in the respective turning direction 22, 24 when a physical contact between the connection element 10 and the mechanical stop element 16 is established. The interlock elements 32 and/or the respective corresponding interlock elements 34, 36 are implemented as circumferentially interlocking teeth. Each of the interlock elements 32 of the mechanical stop element 16 and/or the further mechanical stop element 26 forms a longitudinal stop dog 28 and a rotational stop dog 30. The longitudinal stop dog 28 and the rotational stop dog 30 are divided by an approximately perpendicular edge. The longitudinal stop dog 28 and the rotational stop dog 30 transition directly into each other. In the circumferential direction several interlock elements 32 are arranged directly adjacent to each other forming a jagged wave like side surface of the respective mechanical stop element 16, 26. The corresponding interlock elements 34, 36 on both axial sides of the connection element 10 are shaped the same way but with the surfaces forming the rotational stop dogs 30 facing in the opposite circumferential direction. If, as it is exemplary shown by FIG. 3, the rotational stop dogs 30 of the further mechanical stop element 26 face in a counter-clockwise direction, the rotational stop dogs 30 of the corresponding interlock elements 36 on the side of the connection element 10 closer to the further mechanical stop element 26 face in a clockwise direction. Thereby, the interlocking of the interlocking teeth is achieved when the corresponding interlock elements 36 of the connection element 10 are moving towards the further mechanical stop element 26 in a spiraling fashion.

The mechanical steering wheel turn-end-stop device 52 comprises the sleeve element 48. The sleeve element 48 forms an inner receiving region 50. The inner receiving region 50 is configured to receive the connection element 10. The inner receiving region 50 is configured to receive a part of the steering wheel shaft 12. The inner receiving region 50 is at least substantially cylindrical. The mechanical stop element 16 is arranged at a longitudinal end 54 of the sleeve element 48. The further mechanical stop element 26 is arranged at a further longitudinal end 56 of the sleeve element 48 that is opposite to the longitudinal end 54. The mechanical stop elements 16, 26 form end caps to the sleeve clement 48.

The connection element 10 comprises a movement guide element 44. The movement guide clement 44 is arranged on a radial outer surface 46 of the connection element 10. The movement guide element 44 is implemented as an outer thread. The movement guide element 44 is implemented as an Acme thread. The sleeve element 48 comprises a corresponding (movement) guide element 60. The corresponding guide element 60 is arranged on the inner wall 58 of the sleeve element 48 which faces the connection clement 10. The corresponding guide element 60 is implemented as an inner thread. The corresponding guide element 60 is implemented as an Acme thread. The corresponding guide element 60 is configured to engage with the movement guide element 44 on the radial outer surface 46 of the connection element 10. The inter-engaging guide elements 44, 60 form a cam gear like structure, which forces the connection element to move towards one of the mechanical stop elements 16, 26, when the steering wheel shaft 12 is turned. The movement direction depends on the respective turning direction 22, 24. If, for example, the connection element 10 of FIG. 3 is rotated clockwise, it is moved towards the further mechanical stop element 26. If, for example, the connection element 10 of FIG. 3 is rotated counter-clockwise, it is moved towards the mechanical stop element 16. In FIG. 3, the connection element 10 abuts the mechanical stop element 16. In this configuration, a further turning of the steering wheel shaft 12 in the counter-clockwise direction is mechanically prevented while a turning of the steering wheel shaft 12 in the clockwise direction is allowed for a turning angle of far more than 360°.

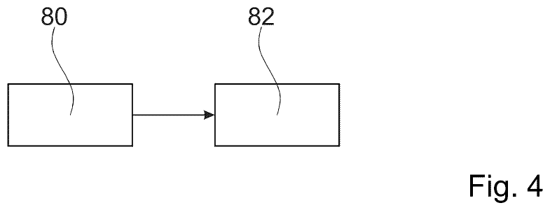

The FIG. 4 shows a schematic flowchart of a method for providing the tactile lock-to-lock steering feedback to a user of a steer-by-wire steering system via the mechanical steering wheel turn-end-stop device 52. In at least one method step 80 turning of the steering wheel shaft 12 produces a rotational and translational movement of the connection element 10 inside the sleeve element 48. In at least a further method step 82, the translational part of this movement leads to a contact of the connection element 10 with one of the mechanical stop elements 16, 26 and a subsequent interlocking of its interlocking elements 32, 34, 36. This interlocking prevents a further turning of the steering wheel shaft 12 and the connected steering wheel 14 one of the turning directions 22, 24. The same effect for the other turning direction 22, 24 is reached by an interaction of the connection element 10 with the other one of the mechanical stop elements 16, 26.

### REFERENCE NUMERALS

10 Connection element
12 Steering wheel shaft
14 Steering wheel
16 Mechanical stop element
18 Movement direction
20 Movement direction
22 Turning direction
24 Turning direction
26 Further mechanical stop element
28 Longitudinal stop dog
30 Rotational stop dog
32 Interlock element
34 Corresponding interlock element
36 Further corresponding interlock element
38 Receiving recess
40 Groove
42 Rib
44 Guide element
46 Outer surface
48 Sleeve element
50 Receiving region
52 Mechanical steering wheel turn-end-stop device
54 Longitudinal end
56 Further longitudinal end
58 Inner Wall
60 Corresponding guide element
62 Steering column
64 Crash tube
66 Upper bearing
68 Lower bearing
70 First end region
72 Second end region
74 Axial direction
76 Striking surface
78 Striking surface
80 Method step
82 Method step
84 Inner Part
86 Outer Part

1. Mechanical steering wheel turn-end-stop device for use in steer-by-wire steering systems,
comprising a connection element, which is configured for establishing a physical connection with a steering wheel shaft of a steering wheel, and which is configured for performing a coupled movement together with a physically connected steering wheel when the steering wheel is turned, and
comprising a mechanical stop element, forming a limit stop for the connection element, preventing a further movement of the connection element in at least one movement direction and, via the established physical connection with the steering wheel shaft, preventing a further turning of the steering wheel shaft in at least one turning direction.

2. The mechanical steering wheel turn-end-stop device according to claim 1, comprising a further mechanical stop element forming a limit stop for the connection element, preventing a further movement of the connection element in at least one further movement direction, which is directed opposite to the movement direction, and, via the established physical connection with the steering wheel shaft, preventing a further turning of the connected steering wheel in at least one further turning direction, which is directed opposite to the turning direction.

3. The mechanical steering wheel turn-end-stop device according to claim 2, wherein the mechanical stop element and the further mechanical stop element are arranged on opposing ends of a longitudinal travel path of the connection element.

4. The mechanical steering wheel turn-end-stop device according to claim 2, wherein the mechanical stop element and the further mechanical stop element are arranged in a way relative to the connection element, allowing turns of the connection element and thus of a connected steering wheel shaft in the turning direction of at least 360°.

5. The mechanical steering wheel turn-end-stop device according to claim 1, wherein the mechanical stop element at the same time implements a longitudinal stop dog preventing a further longitudinal movement of the connection element towards the at least one movement direction and a rotational stop dog preventing a further rotational movement of the connection element in the at least one turning direction.

6. The mechanical steering wheel turn-end-stop device according to claim 5, wherein the mechanical stop element comprises one or more interlock elements, which are configured to interlock with corresponding interlock elements of the connection element in order to prevent a further rotational movement of the connection element in the at least one turning direction when physical contact between the connection element and the mechanical stop element is established.

7. The mechanical steering wheel turn-end-stop device according to claim 6, wherein the interlock elements and/or the corresponding interlock elements are implemented as circumferentially interlocking teeth.

8. The mechanical steering wheel turn-end-stop device according to claim 6, wherein the connection element comprises further corresponding interlock elements on a side of the connection element, which is opposite to the side of the connection element the corresponding interlock elements are located at.

9. The mechanical steering wheel turn-end-stop device according to claim 1, wherein the connection element is configured for establishing a rotationally fixed and longitudinally movable physical connection with a steering wheel shaft.

10. The mechanical steering wheel turn-end-stop device according to claim 1, wherein the connection element comprises a receiving recess for an all-round reception of the steering wheel shaft.

11. The mechanical steering wheel turn-end-stop device according to claim 1, wherein the receiving recess comprises straight grooves and/or ribs, which are configured to engage with straight ribs and/or grooves of the steering wheel shaft in case of a physical connection between the connection element and the steering wheel shaft.

12. The mechanical steering wheel turn-end-stop device according to claim 1, wherein the connection element comprises a movement guide element on a radial outer surface.

13. The mechanical steering wheel turn-end-stop device according to claim 12, wherein the guide element is implemented as an outer thread.

14. The mechanical steering wheel turn-end-stop device according to claim 13, wherein the guide element is implemented as an Acme thread.

15. The mechanical steering wheel turn-end-stop device according to claim 1, comprising a sleeve element forming an at least substantially cylindrical inner receiving region at least for receiving the connection element and the steering wheel shaft.

16. The mechanical steering wheel turn-end-stop device according to claim 15, wherein the mechanical stop element is arranged at a longitudinal end of the sleeve element.

17. The mechanical steering wheel turn-end-stop device according to claim 16, wherein a further mechanical stop element of the mechanical steering wheel turn-end-stop device is arranged at a further longitudinal end of the sleeve element.

18. The mechanical steering wheel turn-end-stop device according to claim 15, wherein the sleeve element on an inner wall facing the connection element comprises a corresponding guide element, which is configured to engage with a movement guide element on a radial outer surface of the connection element.

19. The mechanical steering wheel turn-end-stop device according to claim 18, wherein the corresponding guide element is implemented as an inner thread.

20. The mechanical steering wheel turn-end-stop device according to claim 19, wherein the corresponding guide element is implemented as an Acme thread.

21. The mechanical steering wheel turn-end-stop device according to claim 1, wherein a striking of the limit stop is configured for generating tactile lock-to-lock steering feedback to a user turning the steering wheel.

22. A steering column of a steer-by-wire steering system with the mechanical steering wheel turn-end-stop device according to claim 1 and with the steering wheel shaft.

23. The steering column of claim 22, comprising a crash tube, wherein the mechanical steering wheel turn-end-stop device is mounted inside the crash tube.

24. The steering column of claim 22, comprising an upper bearing supporting the steering wheel shaft in a first end region of the steering wheel shaft and comprising a lower bearing supporting the steering wheel shaft in a second end region of the steering wheel shaft opposite to the first end region, and wherein the connection element of the mechanical steering wheel turn-end-stop device is mounted to the steering wheel shaft between the upper bearing and the lower bearing.

25. A method for providing tactile lock-to-lock steering feedback to a user of a steer-by-wire steering system, wherein a physical connection with a steering wheel shaft of the steering wheel system is established using a steering wheel connection element of a mechanical steering wheel turn-end-stop device, wherein by this connection a coupled movement of the connection element together with the physically connected steering wheel is established when the steering wheel shaft is turned, and wherein a further movement of the connection element in at least one movement direction and, via the established physical connection with the steering wheel shaft, a further turning of the connected steering wheel in at least one turning direction is prevented using a mechanical stop element forming a limit stop for the connection element.
